(19) United States
(12) Patent Application Publication
(10) Pub. No.: US 2008/0050141 A1
(43) Pub. Date: Feb. 28, 2008

(54) Color image forming apparatus, image forming program and color image forming method

(75) Inventor: Yutaka Hosono, Kawasaki-shi (JP)

Correspondence Address: BUCHANAN, INGERSOLL & ROONEY PC, POST OFFICE BOX 1404, ALEXANDRIA, VA, 22313-1404, US

(73) Assignee: KONICA MINOLTA BUSINESS TECHNOLOGIES, INC., Tokyo (JP)

(21) Appl. No.: 11/676,523

(22) Filed: Feb. 20, 2007

(30) Foreign Application Priority Data
Aug. 24, 2006 (JP) 2006-227623

(51) Int. Cl. G03G 15/00

(52) U.S. Cl. 399/82

(57) ABSTRACT

There is described a color image forming apparatus, which makes it possible to increase the printing velocity. The apparatus includes: an image processing section to generate either first-processed image data or second-processed image data; an image forming section to form a first color image based on the first-processed image data at a first image forming velocity in a first image forming mode or a second color image based on the second-processed image data at a second image forming velocity in a second image forming mode onto the sheet; and a control section to conduct a changeover operation between the first image forming mode and the second image forming mode. A maximum amount of total toner consumption in the second image forming mode is smaller than that in the first image forming mode, and the second image forming velocity is faster than the first image forming velocity.

This application is based on Japanese Patent Application No. 2006-227623 filed on Aug. 24, 2006 with Japan Patent Office, the entire content of which is hereby incorporated by reference.

### BACKGROUND

The present invention relates to a color image forming apparatus, an image forming program and a color image forming method, for forming a color image by superimposing a plurality of unicolor toner images onto a paper sheet.

Recently, the tandem-type color image forming apparatus, which makes it possible to conduct a high-speed printing operation of the color image, has been widely used in various kinds of sites, such as an office, etc. For instance, the tandem-type color image forming apparatus, set forth in Patent Document 1 (Tokkai 2003-54080, Japanese Non-Examined Patent Publication), is provided with four photoreceptor drums for forming unicolor toner images of Yellow (Y), Magenta (M), Cyan (C) and Black (Bk), respectively, and the four toner images are sequentially transferred and superimposed one by one onto an intermediate transfer member so as to form a full color toner image on the intermediate transfer member. According to the tandem-type color image forming apparatus mentioned in the above, since the separate unicolor toner images can be simultaneously formed onto the four photoreceptor drums, respectively, it is possible to conduct the high-speed printing operation not only for the monochrome printing operation, but also for the color printing operation.

However, since the color image is formed by superimposing a plurality of unicolor toner images, the time required for fusing the superimposed color toner image is longer than that for fusing the monochrome color toner image, when fixing the color toner image onto a paper sheet. Namely, even if the tandem-type color image forming apparatus is employed for the color printing operation, the time period required for the color printing operation is longer that that required for the monochrome printing operation, due to the excessive time consumption in the fixing process of the color printing operation, as set forth in Patent Document 1 (Tokkai 2003-54080, Japanese Non-Examined Patent Publication).

### SUMMARY

To overcome the abovementioned drawbacks in conventional color image forming apparatus, it is one of objects of the present invention to provide a color image forming apparatus, an image forming program and a color image forming method, which makes it possible to increase the printing velocity even in the color printing operation.

Accordingly, at least one of the objects of the present invention can be attained by the color image forming apparatus described as follows.
(1) According to a color image forming apparatus reflecting an aspect of the present invention, the color image forming apparatus that forms a color image on a sheet by superimposing a plurality of unicolor toner images with each other, comprises: an image processing section to process image data; an image forming section to form a color image; and a control section to conduct a changeover operation between a first image forming mode and a second image forming mode; wherein the image forming section forms at a first image forming velocity a first color image based on first-processed image data processed by the image processing section in the first image forming mode, while the image forming section forms at a second image forming velocity a second color image based on the second-processed image data processed by the image processing section in the second image forming mode; and wherein a maximum amount of total toner consumption in the second image forming mode is smaller than that in the first image forming mode, and the second image forming velocity is faster than the first image forming velocity.
(2) According to another aspect of the present invention, in the color image forming apparatus recited in item 1, the image processing section applies a color conversion processing to image data, and, while conducting the color conversion processing, adjusts at least one color component of image data.
(3) According to still another aspect of the present invention, in the color image forming apparatus recited in item 2, when the image processing section implements the color conversion processing for converting image data of colors R (Red), G (Green), and B (Blue) to image data of colors Y (Yellow), M (Magenta), C (Cyan), and Bk (Black), the image processing section adjusts each of the image data of colors Y (Yellow), M (Magenta), C (Cyan), and Bk (Black) in such a manner that a part or all of at least two of image data of colors Y (Yellow), M (Magenta), and C (Cyan) are replaced with image data of color Bk (Black).
(4) According to yet another aspect of the present invention, in the image forming apparatus recited in item 1, the control section conducts the changeover operation among the first image forming mode, the second image forming mode and a third image forming mode, so that the image forming section forms a monochrome image based on the third-processed image data at a third image forming velocity in the third image forming mode; and the third image forming velocity is faster than the second image forming velocity.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 shows a center cross sectional block diagram of an internal configuration of a color image forming apparatus embodied in the present invention;

FIG. 2 shows a block diagram of a control system of a color image forming apparatus embodied in the present invention;

FIG. 3 shows an explanatory drawing of a setting screen in a printer driver;

FIG. 4 shows a flowchart for explaining a color conversion processing when the “COLOR” mode is selected;

FIG. 5(a), FIG. 5(b) and FIG. 5(c) are explanatory drawings indicating an example of an amount of toner consumption when forming an image based on image data;

FIG. 6 shows a flowchart for explaining a color conversion processing when a “DRAFT COLOR” mode is selected; and

FIG. 7(a), FIG. 7(b), FIG. 7(c), 7(d), FIG. 7(e) and FIG. 7(f) are explanatory drawings indicating an example of an amount of toner consumption when forming an image based on image data.

### DETAILED DESCRIPTION OF THE PREFERRED EMBODIMENT

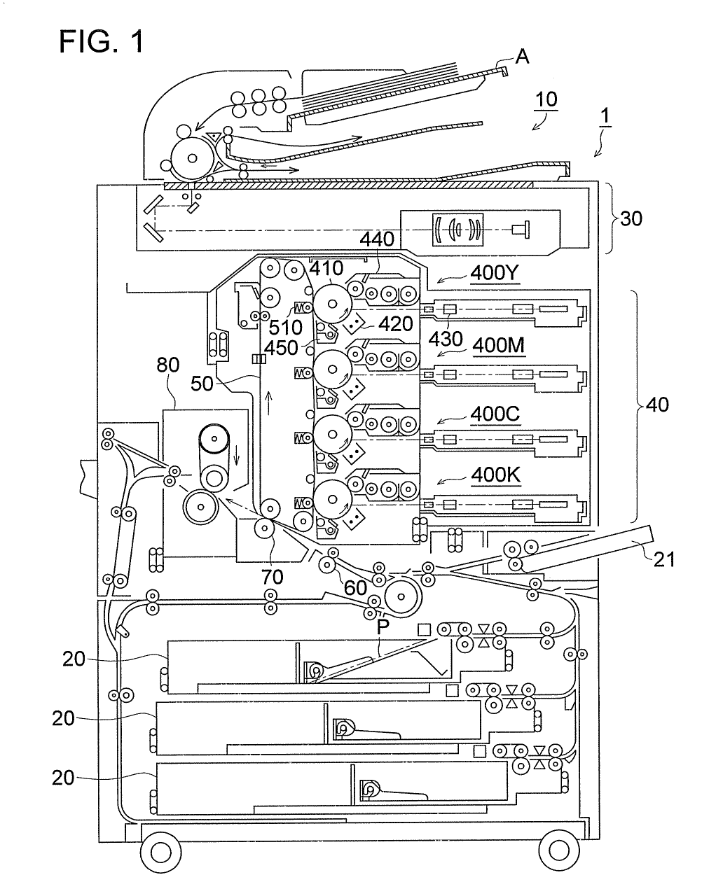

FIG. 1 is a cross sectional view of a color image forming apparatus 1 showing the internal configuration thereof.

The color image forming apparatus 1 is a tandem-type color image forming apparatus provided with an intermediate transfer belt 50.

A document stacked on a document feeding tray A of an automatic duplex-document feeder 10 is conveyed to an image reading section 30 by various kinds of rollers.

The color image forming apparatus 1 is provided with a plurality of recording medium accommodating sections 20 disposed at its lower space. Provided above the recording medium accommodating sections 20 are an image forming section 40 and an intermediate transfer belt 50. Further, an image reading section 30 is provided at the top of the main body.

A recording medium accommodating section 20, being one of the plurality of recording medium accommodating sections 20, is mounted so as to be drawn towards the front side of the color image forming apparatus 1 (namely, in a paper surface frontward direction of the FIG. 1). Various kinds of different-sized standard paper sheets serving as the recording mediums, such as white papers, etc., are divided according to the different standard sizes and accommodated into the plurality of recording medium accommodating sections 20. Special sheets, such as OHP sheets, etc., are stacked onto a manual insertion tray 21.

An image forming section 40 includes four sets of image forming engines 400Y, 400M, 400C, 400K for forming unicolor toner images of color Y (Yellow), color M (Magenta), color C (Cyan) and color K (Black), respectively. The image forming engines 400Y, 400M, 400C, 400K are linearly arranged in this order of an up-to-down direction, and have the same configuration. Accordingly, for explaining the configuration, the image forming engine 400Y is exemplified in the following.

The image forming engine 400Y is provided with a photoreceptor drum 410 rotating in an counterclockwise direction, a scorotron charging device 420, an exposing device 430 and a developing device 440.

A cleaning section 450 is disposed at a lower space of the photoreceptor drum 410 in such a manner that the cleaning section 450 includes an area opposing to the lowest section of the photoreceptor drum 410.

The intermediate transfer belt 50, disposed in a center space of the color image forming apparatus itself, is formed in an endless-belt shape, and has a predetermined volume resistivity. Further, a primary transferring electrode 510 is disposed at such a position that opposes to the photoreceptor drum 410 while putting the intermediate transfer belt 50 therebetween.

Next, the color image forming method for forming the color image will be detailed in the following.

The scorotron charging device 420 uniformly charges the circumferential surface of the photoreceptor drum 410 at a voltage having a negative polarity (for instance, −800 Volts) with its discharging action, while the photoreceptor drum 410 is driven to rotate by a main motor (not shown in the drawings). Then, the exposing device 430 exposes the photoreceptor drum 410 with a light beam modulated by image information, so as to form an electrostatic latent image corresponding to the image information on the photoreceptor drum 410. Successively, when the electrostatic latent image formed on the photoreceptor drum 410 passes through the developing device 440, the yellow toner charged at the negative voltage in the developing device 440 is attracted and adhered to an area of the latent image by applying a negative developing bias to the area, so as to form a Y toner image on the photoreceptor drum 410. The Y toner image formed on the photoreceptor drum 410 is transferred onto the intermediate transfer belt 50, which press-contacts the photoreceptor drum 410. After the abovementioned transferring operation, the residual toner remaining on the photoreceptor drum 410 is cleaned by the cleaning section 450. The separate unicolor toner images respectively formed in the image forming engines 400Y, 400M, 400C, 400K are sequentially transferred one by one onto the intermediate transfer belt 50 in such a manner that the separate unicolor toner images are superimposed on each other, so as to form a full color toner image on the intermediate transfer belt 50. A recording medium P is picked up one by one from one of the plurality of recording medium accommodating sections 20 and conveyed to the position of a pair of registration rollers 60. After the leading edge of the recording medium P is trued by butting it against the pair of registration rollers 60, the pair of registration rollers 60 commences to convey the recording medium P at such a timing that the position of the full color toner image residing on the intermediate transfer belt 50 coincides with that on the recording medium P. The recording medium P, conveyed by the pair of registration rollers 60, is guided by a guide plate, so that the recording medium P can be fed into a transferring nip section formed between the intermediate transfer belt 50 and a secondary transferring section 70. The secondary transferring section 70, including a pair of rollers, press-pushes the recording medium P against the intermediate transfer belt 50. By applying a bias voltage having a polarity opposite to that of the toner image (for instance, +500 Volts) to the secondary transferring section 70, the full color toner image residing on the intermediate transfer belt 50 is transferred onto the recording medium P. The recording medium P is discharged by a separating device including a discharging needle (not shown in the drawings), to separate the recording medium P from the secondary transferring section 70, and conveyed into a fixing section constituted by a pair of a heating roller and a pressing roller. As a result, the full color toner image is fixed onto the recording medium P, and the recording medium P on which the image is already formed, is ejected outside the color image forming apparatus 1.

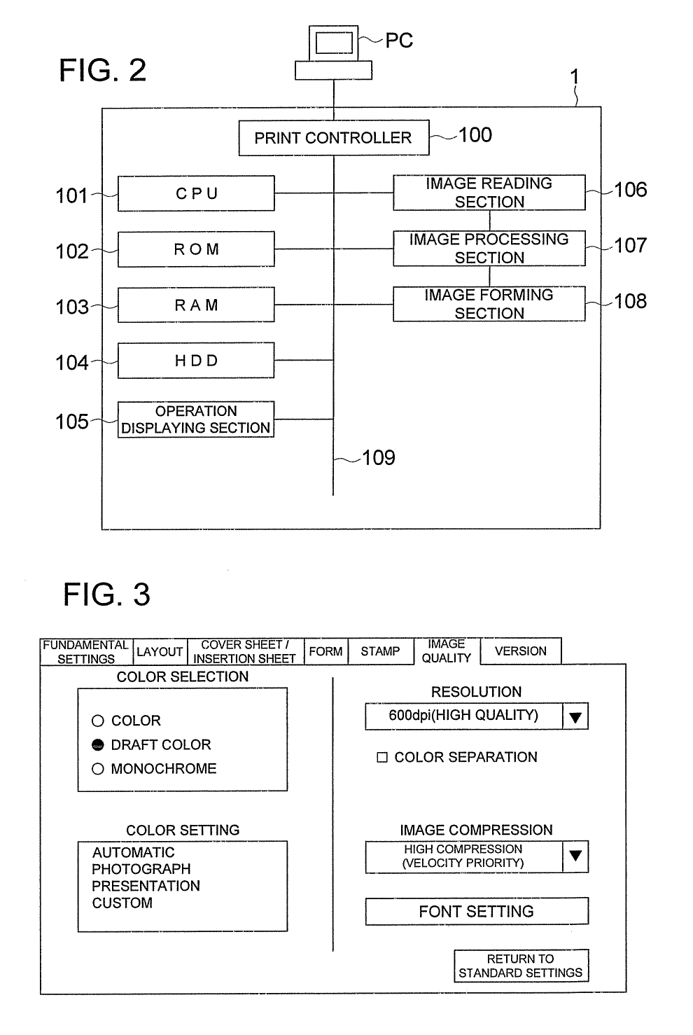

FIG. 2 shows a block diagram of a control system of the color image forming apparatus 1 embodied in the present invention.

A CPU (Central Processing Unit) 101, serving as a controlling section in this embodiment, controls an overall operation of the color image forming apparatus 1, and is coupled to a ROM (Read Only Memory) 102, a RAM (Random Access Memory) 103, etc. through a system bus 109. The CPU 101 reads out various kinds of control programs stored in the ROM 102, and develops the control program into the RAM 103, in order to control the operations of the concerned sections. Further, the CPU 101 executes the control program developed into the RAM 103 in order to conduct various kinds of processing, and stores the results of the processing into the RAM 103 and displays them on an operation displaying section 105. In addition, the CPU 101 stores the results of the processing, temporally stored in the RAM 103, into other predetermined storage destinations.

The ROM 102 stores the programs, the data, etc. in advance, and is constituted by a magnetic recording medium, an optical recording medium or a semiconductor storage device. The image forming program is stored in the ROM 102, so that the color image forming apparatus 1 implements the image forming operations based on the image forming program concerned.

The RAM 103 forms a working area in which the data, etc., processed by executing the various kinds of programs to be executed by the CPU 101, are temporally stored.

An HDD (Hard Disc Drive) 104 has a function for storing the image data acquired by reading the document image from an image reading section 106 and other image data based on which the image is already outputted. The HDD 104 is constituted by a plurality of metallic or glass discs onto each of which a magnetic material is coated or vapor-deposited and which are arranged in parallel at constant intervals in an overlapping state. The data accessing operation is achieved, by making magnetic heads approach the surfaces of plurality of metallic discs, which are currently rotating at a high velocity.

Various kinds of setting items can be inputted and established from the operation displaying section 105. The operation displaying section 105 is formed in, for instance, a touch panel type configuration, so that the user can easily conduct inputting operations for establishing the conditions of the color printing operation or the monochrome printing operation. Further, various kinds of information, such as network setting information, etc., are displayed on the operation displaying section 105.

The image reading section 106 optically reads the document image, and converts the optical signals to electric signals. When reading a color document image, the image reading section 106 generates image data in which luminance data of 10 bits are allotted to each of RGB colors for every one pixel.

An image processing section 107 applies image processing to the image data generated by the image reading section 106 and other image data transmitted from a personal computer coupled to the color image forming apparatus 1. When the color printing operation is conducted in the color image forming apparatus 1, image data of color R (Red), color G (Green) and color B (Blue) generated by the image reading section 106 are inputted into the color conversion LUT (Look Up Table) in the image processing section 107, in order to converts the image data sets of colors R, G, B to other image data of color Y (Yellow), color M (Magenta), color C (Cyan) and color Bk (Black). Then, the image processing section 107 applies various kinds of image processing, such as a compensation for the gradation reproducing characteristics, a screen processing of halftone dot conducted by referring to the density correction LUT, an edge processing for enhancing the narrow lines, etc., to the converted image data of colors Y, M, C, Bk.

An image forming section 108 receives the processed image data, to which the image processing section 107 applied the image processing, and forms an image on a sheet based on the processed image data.

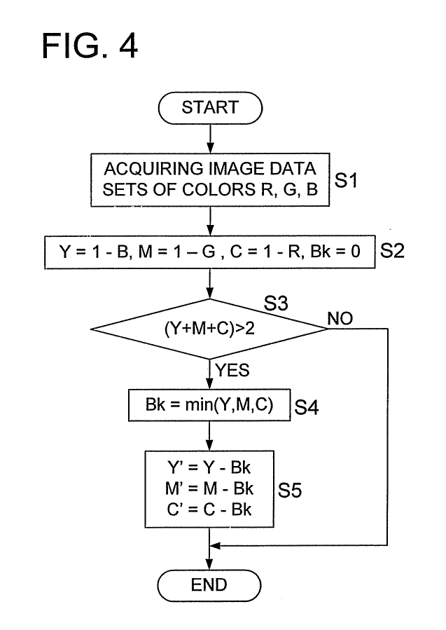

FIG. 3 shows an explanatory drawing of a setting screen in the printer driver.

The setting screen shown in FIG. 3 is displayed on the display screen of the personal computer coupled to the color image forming apparatus 1. Various kinds of printing conditions are settable through this setting screen. The setting screen is provided with various kinds of tabs, and, when the tab of “IMAGE QUALITY” is selected, it becomes possible to set the setting items of “COLOR SELECTION”, “COLOR SETTING”, “RESOLUTION”, etc.

In the setting item of “COLOR SELECTION”, it is possible to select any one of three separate modes, including “COLOR” being the first image forming mode, “DRAFT COLOR” being the second image forming mode, “MONOCHROME” being the third image forming mode. When any one of the three separate modes is selected, a signal corresponding to the selected one is notified to the CPU 101, so that CPU 101 can change the current mode to the selected mode. The CPU 101 sets the image forming velocity, the developing bias voltage, etc. in each of the three separate modes. The first image forming velocity in the “COLOR” mode being the first image forming mode is set at 185 mm/sec. (the value with respect to the paper sheet conveyance velocity), the second image forming velocity in the “DRAFT COLOR” mode being the second image forming mode is set at 216 mm/sec. (the value with respect to the paper sheet conveyance velocity) and the third image forming velocity in the “MONOCHROME” mode being the third image forming mode is set at 230 mm/sec. (the value with respect to the paper sheet conveyance velocity). The second image forming velocity set for the “DRAFT COLOR” mode is greater than the first image forming velocity set for the “COLOR” mode, while the third image forming velocity set for the “MONOCHROME” mode is greater than the second image forming velocity set for the “DRAFT COLOR” mode.

When the “COLOR” mode is selected, the normal color printing operation is performed. On the other hand, when the “DRAFT COLOR” mode is selected, adjustments are conducted in the color conversion processing, in order to implement a special color printing operation, which makes it possible to reduce an amount of toner consumption to a level lower than that of the normal color printing operation when reproducing a high-density image. Concretely speaking, any one of the two color printing modes is selectable in the color image forming apparatus 1, and specifically, in the color printing operation of the “DRAFT COLOR” mode, not only the maximum amount of toner consumption is small, but also the image forming velocity is high, compared to those in the color printing operation of the “COLOR” mode. When the “MONOCHROME” mode is selected, the monochrome printing operation is implemented by employing the black toner only. Incidentally, it is also applicable that the operation displaying section 105 is made to display such the setting screen as shown in FIG. 3 on it. According to this configuration, even for a copy operation of the color document, it becomes possible to set any one of the “COLOR” and “DRAFT COLOR” modes, etc., as well.

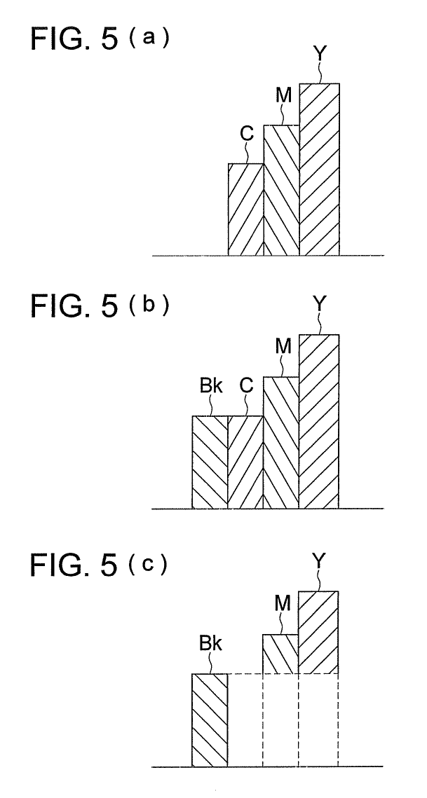

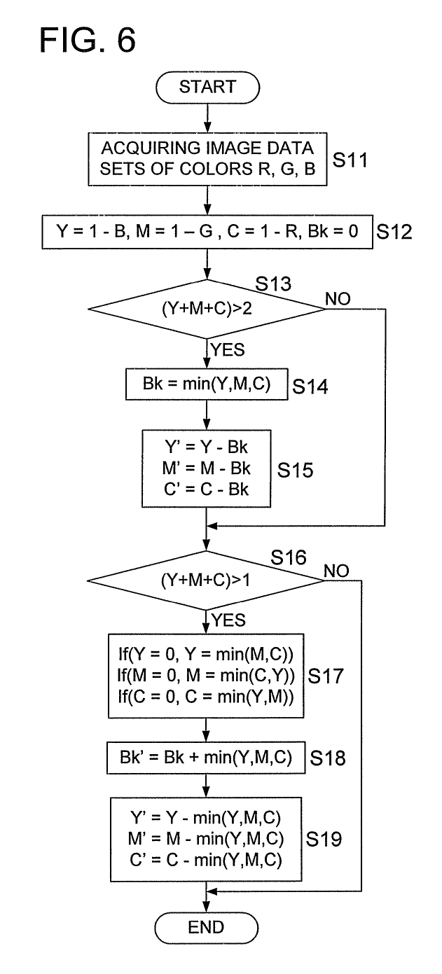

Referring to FIG. 4, FIG. 5(a), FIG. 5(b) and FIG. 5(c), a color image forming method, to be implemented by employing the setting screen shown in FIG. 3 when the “COLOR” mode is selected, will be detailed in the following.

FIG. 4 shows a flowchart for explaining the color conversion processing when the “COLOR” mode is selected, while FIG. 5(a), FIG. 5(b) and FIG. 5(c) are explanatory drawings indicating an example of an amount of toner consumption when forming an image based on image data.

When the “COLOR” mode is selected by using the setting screen shown in FIG. 3, the image processing section 107 implements the color conversion processing according to the flowchart shown in FIG. 4. The CPU 101 reads out an image forming program from the ROM 102 and stores it into the RAM 103, so as to implement the operations according to the flowchart shown in FIG. 4 by executing the image forming program stored in the RAM 103. Herein, when assuming that a black solid image is printed at a maximum density, total 300% of toner, including 100% of Yellow toner, 100% of Magenta toner, 100% of Cyan toner, is consumed at maximum. However, in the present embodiment, the maximum amount of toner consumption for the color printing operation is established at a value being twice of the maximum amount of toner consumption for a single color, namely, at 200%. This is because, the toner residing on the paper sheet is made to stably fix onto the paper sheet without causing any toner peeling-off defect, etc., in the fixing section of the color image forming apparatus 1. As will be detailed in the following, in order to limit the maximum amount of toner consumption to 200%, the image processing section 107 performs the UCR processing (Under Color Removal processing) in the color image forming apparatus 1 embodied in the present invention.

Now, the flowchart shown in FIG. 4 will be detailed in the following. Initially, the image processing section 107 acquires the image data of colors R, G, B (Step S1). The image processing section 107 acquires the image data of colors R, G, B from the image reading section 106 or the personal computer coupled to the color image forming apparatus 1.

Next, in order to implement the color printing operation in the image forming section 108, the image processing section 107 conducts the color conversion processing for converting the image data of colors R, G, B to converted image data of colors Y, M, C, Bk for every pixel. In order to implement the color printing operation, an image data for color Bk is established at zero, while other image data for colors Y, M, C are calculated by employing the equations indicated as follow (Step S2).

Y=1−B, M=1−G, C=1−R

Herein, it is assumed, for instance, that amounts of toner consumptions calculated for a certain pixel based on the image data of colors Y, M, C are such values as indicated in FIG. 5(a).

Next, a total value of the image data of colors Y, M, C is found by adding them to each other, so as to determine whether or not the total value exceeds 2 (being a value corresponding to 200% of toner consumption) (Step S3). When the total value is equal to or smaller than 2, it is possible to implement the color printing operation without generating any problem, and accordingly, the color conversion processing to be conducted by the image processing section 107 is finalized. On the other hand, when the total value exceeds 2, the amount of toner consumption exceeds its upper limit, and accordingly, the image processing section 107 conducts the adjustment (UCR processing) for replacing at least part of the image data for colors Y, M, C with the image data for color Bk.

At first, the image data for color Bk is made to match with the smallest one among the image data for colors Y, M, C (Step S4). Explaining with reference to FIG. 5(b), since the smallest one among the image data sets for colors Y, M, C is the image data set of color C, the image data for color Bk is made to match with the image data set of color C.

Next, the values derived by subtracting the image data of color Bk from the original image data of colors Y, M, C are established as new image data (except image data of color Bk) (Step S5). Provided that the original image data are defined as Y, M, C, while the new image data are defined as Y′, M′, C′, the new image data sets are calculated by employing the equations indicated as follow.

Y′=Y−Bk, M′=M−Bk, C′=C−Bk

Explaining with reference to FIG. 5(c), the amount of toner consumption of the new image data set for color C becomes zero, while the amounts of toner consumptions of the new image data sets for colors Y, M is calculated as differential values between those for colors Y, M and that for color Bk. The total value of the substituted values becomes equal to the amount of color Bk component. Accordingly, if the black unicolor image is reproduced with toner of color Bk based on the abovementioned image data of color Bk, no problem for the color reproducibility would occur. Further, since a total amount of toner consumption can be effectively suppressed as a whole, it becomes possible to stably fix the toner onto the paper sheet. Still further, since the processing as mentioned above are conducted for every pixel residing all over the image, it becomes possible to suppress the total amount of toner consumption to a level equal to or lower than 200% of that in the monochrome image forming mode as a whole image, even in the color printing operation of the “COLOR” mode. Accordingly, even if the image forming operation is conducted at the image forming velocity of 185 mm/sec, it becomes possible to form a good color image without generating any fixing defect.

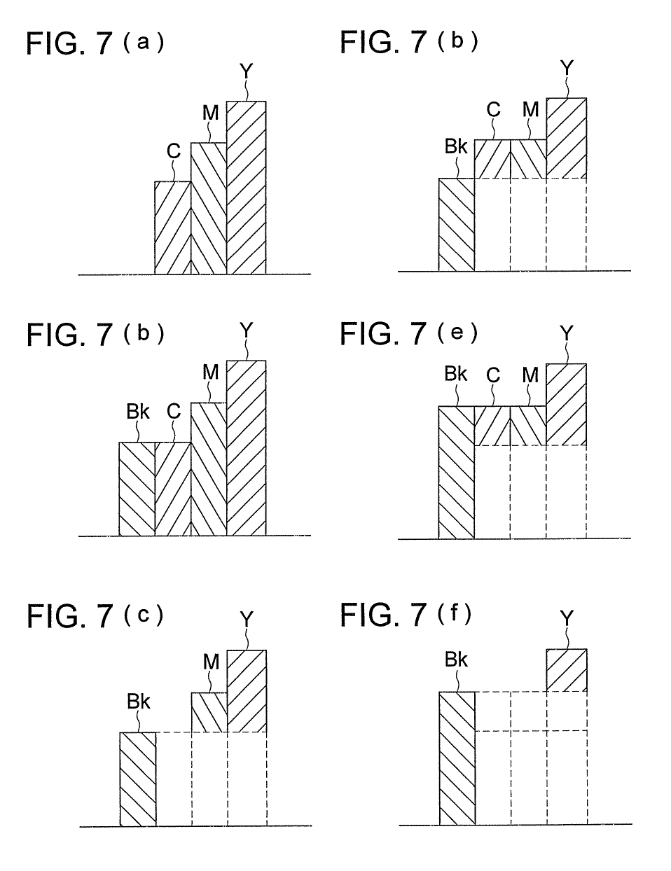

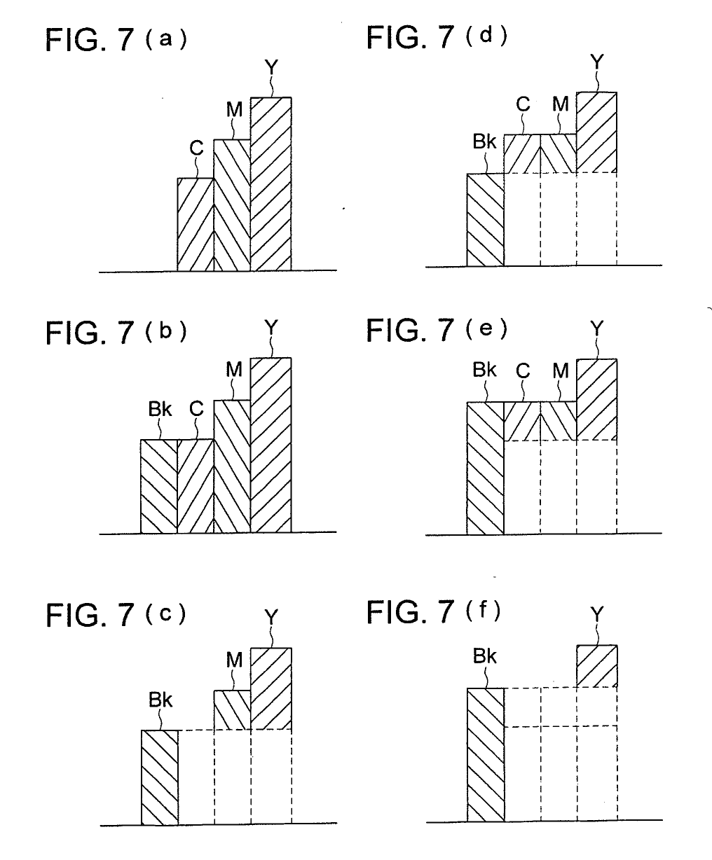

Successively, referring to FIG. 6, FIG. 7(a), FIG. 7(b), FIG. 7(c), 7(d), FIG. 7(e) and FIG. 7(f), a color image forming method, to be implemented by employing the setting screen shown in FIG. 3 when the “DRAFT COLOR” mode is selected, will be detailed in the following.

FIG. 6 shows a flowchart for explaining the color conversion processing when the “DRAFT COLOR” mode is selected, while FIG. 7(a), FIG. 7(b), FIG. 7(c), 7(d), FIG. 7(e) and FIG. 7(f) are explanatory drawings indicating an example of an amount of toner consumption when forming an image based on image data.

When the “DRAFT COLOR” mode is selected by using the setting screen shown in FIG. 3, the image processing section 107 implements the color conversion processing according to the flowchart shown in FIG. 6. The CPU 101 reads out an image forming program from the ROM 102 and stores it into the RAN 103, so as to implement the operations according to the flowchart shown in FIG. 6 by executing the image forming program stored in the RAM 103. In the “DRAFT COLOR” mode, the maximum amount of toner consumption (the second amount of toner consumption) for the color printing operation is established at a value being equal to the maximum amount of toner consumption for a single color, namely, at 100%.

Step S11 through Step S15 indicated in FIG. 6 are the same as Step S1 through Step S5 indicated in FIG. 4, and FIG. 7(a), FIG. 7(b) and FIG. 7(c) are the same as FIG. 5(a), FIG. 5(b) and FIG. 5(c). In other words, in Step S11 through Step S15, the color conversion processing is conducted in such a manner that the maximum amount of toner consumption for a single pixel is made to be equal to or smaller than twice of the maximum amount of toner consumption for the single pixel of a single color, namely, 200%.

Next, a total value of the image data sets for colors Y, M, C is found by adding them to each other, so as to determine whether or not the total value exceeds 1 (being a value corresponding to 100% of toner consumption) (Step S16). By suppressing the amount of toner consumption in such the manner as mentioned in the above, it becomes possible to shorten the time period required for the fixing processing, and accordingly, it becomes possible to increase the image forming velocity of the color printing operation in the “DRAFT COLOR” mode, compared to that in the “COLOR” mode.

When the total value is equal to or smaller than 1, it is possible to implement the color printing operation at a high image forming velocity, and accordingly, the color conversion processing to be conducted by the image processing section 107 is finalized. On the other hand, when the total value exceeds 1, the amount of toner consumption exceeds its upper limit, and accordingly, the image processing section 107 conducts the adjustment for replacing at least a part of the image data for colors Y, M, C with the image data for color Bk.

At first, when image data for a specific color among colors Y, M, C is zero, the level of the image data for the specific color is made to match with that of an image data for another color, which is smaller one among the image data for colors other than the specific color (Step S17). For instance, when the image data for color Y is zero, the level of the image data for color Y is made to match with that of image data for another color, which is smaller one among the image data sets for colors M, C. Explaining with reference to FIG. 7(d), since the image data for color C is zero, the level of the image data set for color Y is made to match with that of the image data for color M.

Then, a value derived by adding the image data for one of colors Y, M, C, having the smallest level among them, to the original image data for color Bk is established as new image data for color Bk (Step S18), as indicated in FIG. 7(e).

Successively, the values derived by subtracting one of the image data for colors Y, M, C, having the smallest level among them, from the original image data of colors Y, M, C (except image data of color Bk) are established as new image data (except image data of color Bk) (Step S19). Provided that the original image data are defined as Y, M, C, while the new image data are defined as Y′, M′, C′, the new image data are calculated by employing the equations indicated as follow.

Y′=Y−min(Y, M, C),

M′=M−min(Y, M, C),

C′=C−min(Y, M, C)

Explaining with reference to FIG. 7(f), the amounts of toner consumptions of the new image data for colors C, M become zero, while the amount of toner consumption of the new image data for color Y is calculated as differential values between those for colors C, M and that for color Y. The subtracted image data (min(Y, M, C)) becomes the color Bk component. If this is added to the image data of color Bk so as to create a new image data of color Bk and to reproduce the black unicolor image with toner of color Bk based on the new image data of color Bk, no considerable obstruction for the color reproducibility would occur.

By applying such the processing as described by referring FIG. 6 and FIGS. 7(a)-7(f) to every pixel residing all over the image, it becomes possible to suppress the total amount of toner consumption for forming all over the image to a level equal to or lower than the maximum amount of toner consumption for a single color image, namely, 100%.

Comparing the “COLOR” mode and the “DRAFT COLOR” mode with each other, the color printing operation is possible in the both modes, and by selecting the “DRAFT COLOR” mode, it becomes possible not only to suppress the amount of toner consumption, but also to increase the velocity of the color printing, without generating any considerable obstruction for the color reproducibility.

In the foregoing, the embodiments of the present invention have been described by referring to the drawings. However, the scope of the present invention is not limited to the aforementioned embodiments. Related embodiments to be possibly derived form the aforementioned embodiments by a skilled person without departing from the spirit and scope of the present invention shall be included in the scope of the present invention.

According to the color image forming apparatus, the image forming program and the color image forming method, explained in the above embodiment, it becomes possible to increase the printing velocity even in the color printing operation.

While the preferred embodiments of the present invention have been described using specific term, such description is for illustrative purpose only, and it is to be understood that changes and variations may be made without departing from the spirit and scope of the appended claims.

What is claimed is:

1. A color image forming apparatus that forms a color image on a sheet by superimposing a plurality of unicolor toner images with each other, comprising:
an image processing section to process image data;
an image forming section to form a color image; and
a control section to conduct a changeover operation between a first image forming mode and a second image forming mode;
wherein the image forming section forms at a first image forming velocity a first color image based on first-processed image data processed by the image processing section in the first image forming mode, while the image forming section forms at a second image forming velocity a second color image based on the second-processed image data processed by the image processing section in the second image forming mode; and
wherein a maximum amount of total toner consumption in the second image forming mode is smaller than that in the first image forming mode, and the second image forming velocity is faster than the first image forming velocity.

2. The color image forming apparatus of claim 1,
wherein the image processing section applies a color conversion processing to image data, and, while conducting the color conversion processing, adjusts at least one color component of image data.

3. The color image forming apparatus of claim 2,
wherein, when the image processing section implements the color conversion processing for converting image data of colors R (Red), G (Green), and B (Blue) to image data of colors Y (Yellow), M (Magenta), C (Cyan), and Bk (Black), the image processing section adjusts each of the image data of colors Y (Yellow), M (Magenta), C (Cyan), and Bk (Black) in such a manner that a part or all of at least two of image data of colors Y (Yellow), M (Magenta), and C (Cyan) are replaced with image data of color Bk (Black).

4. The color image forming apparatus of claim 1,
wherein the control section conducts the changeover operation among the first image forming mode, the second image forming mode and a third image forming mode, so that the image forming section forms a monochrome image based on the third-processed image data at a third image forming velocity in the third image forming mode; and
wherein the third image forming velocity is faster than the second image forming velocity.

5. A computer-readable storage medium that stores a program to be executed in a color image forming apparatus, which includes: an image processing section, to process image data; an image forming section to form a color image based on the processed image data processed by the image processing section, on a sheet; and a control section to control the image processing section and the image forming section, the control section executing the program to carry out a changeover operation between a first image forming mode and a second image forming mode;
wherein the image forming section forms at a first image forming velocity a first color image based on first-processed image data processed by the image processing section in, the first image forming mode, while the image forming section forms at a second image forming velocity a second color image based on the second-processed image data processed by the image processing section in the second image forming mode; and a maximum amount of total toner consumption in the second image forming mode is smaller than that in the first image forming mode, and the second image forming velocity is faster than the first image forming velocity.

6. The computer-readable storage medium of claim 5,
wherein, to conduct one of the first image forming mode and the second image forming mode, the control section controls executing the program controls the image processing section to apply a color conversion processing to image data, in which at least one color component of the image data is adjusted.

7. The computer-readable storage medium of claim 6,
wherein, when the image processing section implements the color conversion processing for converting image data of colors R (Red), G (Green), and B (Blue) to image data of colors Y (Yellow), M (Magenta), C (Cyan), and Bk (Black), the control section executing the program controls the image processing section to adjust each of the image data of colors Y (Yellow), M (Magenta), C (Cyan), and Bk (Black) in such a manner that at least part of at least two of image data of colors Y (Yellow), M (Magenta), and C (Cyan) are replaced with image data of color Bk (Black).

8. The computer-readable storage medium of claim 5,
wherein the control section executing the program conducts the changeover operation among the first image forming mode, the second image forming mode and a third image forming mode, so that the image forming section forms a monochrome image based on the third-processed image data at a third image forming velocity in the third image forming mode; and
wherein the third image forming velocity is faster than the second image forming velocity.

9. A method for forming a color image on a sheet by superimposing a plurality of unicolor toner images with each other, comprising:
conducting a changeover operation between a first image forming mode and a second image forming mode;
processing, under the first image forming mode, image data to generate first-processed image data;
forming, under the first image forming mode, a first color image based on the first-processed image data at a first image forming velocity;
processing, under the second image forming mode, image data to generate second-processed image data; and
forming, under the second image forming mode, a second color image based on the second-processed image data at a second image forming velocity;
wherein a maximum amount of total toner consumption in the second image forming mode is smaller than that in the first image forming mode, and the second image forming velocity is faster than the first image forming velocity.

10. The method of claim 9,
wherein, to conduct one of the first image forming mode and the second image forming mode, a color conversion processing is applied to image data, in which at least one color component of image data is adjusted.

11. The method of claim 10,
wherein, when the color conversion processing for converting image data of colors R (Red), G (Green), and B (Blue) to image data of colors Y (Yellow), M (Magenta) is implemented, C (Cyan), and Bk (Black), each of the image data of colors Y (Yellow), M (Magenta), C (Cyan), and Bk (Black) is adjusted in such a manner that at least part of at least two of image data of colors Y (Yellow), M (Magenta), and C (Cyan) are replaced with image data of color Bk (Black).

12. The method of claim 9,
wherein the changeover operation among the first image forming mode, the second image forming mode and a third image forming mode is conducted, so that a monochrome image is formed, based on the third-processed image data at a third image forming velocity in the third image forming mode; and
wherein the third image forming velocity is faster than the second image forming velocity.
